(19) United States
(12) Patent Application Publication
(10) Pub. No.: US 2010/0254711 A1
(43) Pub. Date: Oct. 7, 2010

(54) METHOD AND APPARATUS FOR PERFORMING DIRECT CURRENT (DC) OFFSET CANCELLATION IN AN OPTICAL COMMUNICATIONS DEVICE

(75) Inventor: Frederick W. Miller, Santa Clara, CA (US)

Correspondence Address: Kathy Manke;Avago Technologies Limited, 4380 Ziegler Road, Fort Collins, CO, 80525, US

(73) Assignee: AVAGO TECHNOLOGIES FIBER IP (SINGAPORE) PTE. LTD., SINGAPORE (SG)

(21) Appl. No.: 12/417,919

(22) Filed: Apr. 3, 2009

(51) Int. Cl. H04B 10/00

(52) U.S. Cl. 398/136

(57) ABSTRACT

An apparatus and method are provided that enable a direct current (DC) offset cancellation (OC) feedback control loop of an optical TX or optical RX to be opened and closed and the bandwidth (BW) of the loop to be adjusted based on a status of an input signal to the RX or TX. Opening and closing the loop and adjusting the BW of the loop allows lower data rates to be achieved and allows relatively long patterns of consecutive 1s or 0s to be transmitted or received without being cancelled out due to the low cutoff frequency of the loop. In addition, opening and closing the loop and adjusting its BW allows the foregoing advantages to be realized without causing an increase in the startup settling time period or in the signal detection time period of the optical TX or RX.

### TECHNICAL FIELD OF THE INVENTION

The invention relates to optical communications systems. More particularly, the invention relates to performing DC offset cancellation in an optical communications device.

### BACKGROUND OF THE INVENTION

A typical optical transceiver module currently used in optical communications includes a transmitter portion and a receiver portion. The transmitter (TX) portion includes a laser driver, which is typically an integrated circuit (IC), one or more laser diodes, and an optics system. The laser driver outputs electrical signals to the laser diodes to modulate them. When the laser diodes are modulated, they output optical signals, which are then directed by the optics system of the TX portion onto the ends of respective transmit optical fibers or waveguides held within a connector that mates with the transceiver module. The TX portion typically also includes an open loop or closed loop optical output power control system for maintaining the average optical output power levels of the lasers at substantially constant levels. Open loop optical output power control systems do not directly measure the optical output power levels of the laser diodes, but rather, rely on temperature, age and/or other parameters to determine adjustments that are to be made to the bias and/or modulation current levels of the laser diodes to maintain them at substantially constant average output power levels. Closed loop optical output power control systems use monitor photodiodes in the TX portion to monitor the output power levels of the laser diodes and to adjust the modulation and/or bias current levels of the laser diodes such that the average output power levels of the laser diodes are maintained at substantially constant levels.

The receiver (RX) portion of the optical transceiver module typically includes one or more receive photodiodes for detecting optical data signals received over one or more optical fibers and for producing corresponding electrical signals. The RX portion includes electrical circuitry for detecting and processing the electrical signals produced by the receive photodiodes. In addition, the RX portions of high-speed optical transceiver modules typically also include DC offset cancellation circuits for cancelling input DC offset and obtaining an optimum slicing threshold for maximum performance.

FIG. 1 illustrates a block diagram of an RX portion 2 of a typical high-speed optical receiver or transceiver module that includes a DC offset cancellation system for cancelling out the DC offset. The RX portion 2 typically includes a transimpedance amplifier (TIA) 4, a limiting amplifier (LA) 5, a signal detection circuit 6, an optical input power monitoring circuit 7, a DC offset cancellation circuit 8, and a photodetector 11. The RX portion 2 operates as follows. The photodetector 11, which is typically a P-inversion-N (PIN) photodiode, produces an electrical current signal in response to light detected by the photodetector 11. The optical input power monitoring circuit 7 detects this electrical current signal and outputs a signal on line 12 that provides a measure of the optical power being received at the photodetector 11. This measure of the optical power being received at the photodetector 11 is typically a voltage or current that is proportional to the optical power incident upon the photodetector 11 that is converted elsewhere in the system to a digital value using an analog-to-digital converter (ADC).

The TIA 4 receives a single-ended voltage signal from the photodetector 11 and compares the voltage signal to a slicing threshold (TH) voltage level and produces a differential voltage signal. This differential voltage signal is then input to the LA 5 and to the signal detection circuit 6. The LA 5 is a high gain differential amplifier that quantizes or digitizes the differential voltage signal output from the TIA 4. The signal detection circuit 6 measures the amplitude of the differential voltage signal output from the TIA 4, compares it to a TH voltage level, and produces an output signal on line 13, which the control circuitry (not shown) uses to determine whether the signal amplitude of the input optical signal is sufficiently large to indicate that optical power is being detected by the photodetector 11. The LA 5 quantizes, or limits, the voltage signal received by the LA 5 from the TIA 4 to produce a limited voltage signal on line 14.

The DC offset cancellation circuit 8 is used to help ensure that the slicing TH voltage level of the TIA 4 is kept as accurate as possible. As indicated above, in the TIA 4, a single ended to differential conversion of the input voltage signal takes place. The DC offset cancellation circuit 8 subtracts off the DC component of the incoming signal from the PIN 11 so that the amplified voltage signal and the slicing TH voltage level are correctly aligned to achieve a minimum bit error rate (BER). At higher data rates, there is less margin level than at lower data rates for the TIA 4 to select the proper slicing TH voltage level. For this reason, the DC offset cancellation circuit 8 is more critical for RXs that operate at higher data rates in order to achieve a particular BER, whereas it is sometimes not needed to achieve the same BER in RXs that operate at much lower data rates.

One of the problems with RX portion of the type shown in FIG. 1 is that the DC offset cancellation circuit 8 has a low cutoff bandwidth that imposes limitations on the data rate or data pattern that can be used with the RX portion 2. If the data frequency content is too low for the achievable low cutoff frequency (i.e., within the bandwidth of the loop), the DC offset cancellation circuit 8 will effectively respond to the long data run length (1 or 0) as if it were a DC offset and cancel out data, resulting in bit errors. Even if the data rate is high, long strings of consecutive logic 1s or logic 0s can induce frequency components below the cutoff frequency that will be cancelled out, causing excess jitter, and ultimately, bit errors. One solution to this problem is to design the DC offset cancellation circuit 8 to have an even lower cutoff bandwidth. Using discrete components (e.g., resistors and capacitors) that have larger values in the DC offset cancellation circuit 8 will generally lower the cutoff bandwidth of the DC offset cancellation circuit 8. However, the sizes that these discrete components are limited by the ability to integrate them into the receiver integrated circuit (IC). For example, capacitors that can be integrated into an IC are very small, which means that the die area that is needed to obtain the necessary capacitance values will be greater, resulting in increased die area and cost.

Another problem with lowering the cutoff bandwidth of the DC offset cancellation circuit 8 is that doing so increases the link startup time period and signal detect time period. The DC offset cancellation circuit 8 includes a lowpass filter (LPF) (not shown) that integrates the output of the TIA 4 to obtain an average value, which corresponds to the DC offset. The RX startup time period is dominated by the amount of time that is required for the LPF to settle to its steady state value. The output of the signal detection circuit 6 is not valid and cannot be used until after the LPF of the DC offset cancellation circuit 8 has settled to its steady state. Therefore, the output of the signal detection circuit 6 cannot be considered valid until after the LPF has settled to its steady state. This entire time period including the LPF settling period is included in the signal detect response time. Because there are usually system imposed limits on how long these time periods can be, there is, in turn, a lower limit that is placed on the cutoff frequency of the DC offset cancellation circuit 8. The lower limit set by response timing and the upper limit set by pattern run lengths (i.e., low frequency data pattern content) can often be in conflict with one another.

Accordingly, a need exists for a DC offset cancellation system and method that are suitable for use in optical RXs, TXs and transceivers and that allow lower data rates to be achieved and relatively long patterns of consecutive logic 1s or consecutive logic 0s to be transmitted and received. A need also exists for a DC offset cancellation system and method that do not result in increased startup settling time periods or increased signal detection time periods.

### SUMMARY OF THE INVENTION

The invention is directed to an apparatus and method for use in a communications device for performing DC offset cancellation (OC). The apparatus comprises a DC OC feedback loop, a signal transition detection (XD) circuit, and a controller device. The DC OC feedback loop has a first node that is electrically coupled to the TIA of the communications device and a second node that is electrically coupled to an output of a gain stage of the communications device. The feedback loop includes a DC OC circuit and a low pass filter (LPF) circuit. The LPF circuit has a bandwidth (BW) that is adjustable. The LPF circuit has an input that is electrically coupled to the second node of the feedback loop and an output that is electrically coupled to an input of the DC OC circuit. The DC OC circuit has an output that is electrically coupled to the first node of the feedback loop. The signal XD circuit is electrically coupled to the output of the gain stage and is configured to detect signal data transitions in an input signal to the communications device between logic levels (1 to 0 or 0 to 1). The signal XD circuit is configured to output an indication of whether or not at least one signal transition has been detected thereby. The controller device is electrically coupled to the DC OC circuit, the LPF and the signal XD circuit and is configured to perform a feedback loop control (FLC) algorithm. The controller device receives the indication output from the signal XD circuit. The FLC algorithm enables the DC OC circuit to perform DC OC based at least in part on the indication received by the controller device from the signal XD circuit. The FLC algorithm disables the DC OC circuit from performing DC OC based at least in part on the indication received by the controller device from the signal XD circuit.

The method includes providing a DC OC feedback loop in the communications device having a DC OC circuit and a low pass filter (LPF), providing a signal XD circuit in the communications device, providing a controller device configured to perform a feedback loop control (FLC) algorithm in a controller device, and with the controller device, the FLC algorithm causing the DC OC circuit to be enabled and disabled based at least in part on the indication received by the controller device from the signal XD circuit. The feedback loop has a first node that is electrically coupled to the TIA of the communications device and a second node that is electrically coupled to an output of a gain stage of the communications device. The LPF has a BW that is adjustable. An input of the LPF circuit is electrically coupled to the second node of the feedback loop. An output of the LPF that is electrically coupled to an input of the DC OC circuit. The DC OC circuit has an output that is electrically coupled to the first node of the feedback loop. The signal XD circuit is electrically coupled to the output of the gain stage and it configured to detect signal data transitions in an input signal to the communications device between logic levels (1 to 0 or 0 to 1). The signal XD circuit is configured to output an indication of whether or not at least one signal transition has been detected. The controller device receives the indication from the signal XD circuit and the FLC algorithm causes the DC OC circuit to be enabled to perform DC OC and disabled from performing DC OC based at least in part on the indication received in the controller device from the signal XD circuit.

These and other features and advantages of the invention will become apparent from the following description, drawings and claims.

### BRIEF DESCRIPTION OF THE DRAWINGS

FIG. 1 illustrates a block diagram of an RX portion of a typical high-speed optical receiver or transceiver module.

FIG. 2 illustrates a block diagram of an optical RX that includes a DC offset cancellation system in accordance with an embodiment.

FIG. 3 illustrates a flowchart that represents a DC offset cancellation method performed by an RX in accordance with an embodiment.

FIG. 4 illustrates a state diagram that represents a DC offset cancellation method performed by an RX in accordance with an embodiment.

FIG. 5 illustrates a block diagram of an optical TX that includes a DC offset cancellation system in accordance with an embodiment.

### DETAILED DESCRIPTION OF AN ILLUSTRATIVE EMBODIMENT

In accordance with the invention, an apparatus and method are provided that enable a feedback control loop of an optical TX or optical RX to be opened and closed and the bandwidth (BW) of the loop to be adjusted based on a status of an input signal to the RX or TX. Opening and closing the loop and adjusting the BW of the loop allows lower data rates to be achieved and allows relatively long patterns of consecutive 1s or 0s to be transmitted or received without being cancelled out due to the low cutoff frequency of the loop. In addition, opening and closing the loop and adjusting its BW allows the foregoing advantages to be realized without causing an increase in the startup settling time period or in the signal detection time period of the optical TX or RX. The apparatus and method may be incorporated into a stand-alone optical RX, a stand-alone optical TX, or an optical transceiver that includes an RX portion and a TX portion. The term “optical communications device”, as that term is used herein, is intended to denote a stand-alone optical TX, a stand-alone optical RX, and an optical transceiver that includes both an optical TX and an optical RX.

In accordance with one embodiment, the method and apparatus are incorporated into a DC offset cancellation system that is configured to be disabled and enabled and to have its BW adjusted based on the status of the incoming data signal. A controller device of the optical communications device is configured to perform a feedback loop control algorithm that controls the DC offset cancellation loop. If the feedback loop control algorithm determines that the status of the incoming data signal indicates that data (i.e., a pattern of logic 1s and/or logic 0s) is being received, the control algorithm enables the DC offset cancellation system so that DC offset cancellation is performed by the DC offset cancellation system. If the loop control algorithm determines that the status of the incoming data signal indicates that data is not being received, or that the current data pattern is very low in frequency (i.e., below the cutoff frequency of the DC offset cancellation system), the control algorithm disables the DC offset cancellation system so that DC offset cancellation is not performed. Thus, if the incoming data signal has run lengths that are below the cutoff frequency of the DC offset cancellation system, the data will not be cancelled out by the DC offset cancellation system. In addition, the BW of the DC offset cancellation system is preferably set to a higher BW at startup for faster settling and is set to a lower BW at a later instant in time. By adjusting the BW of the DC offset cancellation system in this manner, the optical RX or TX has a shorter settling time period and a shorter signal detection time period at startup than known optical TXs and RXs that use DC offset cancellation systems.

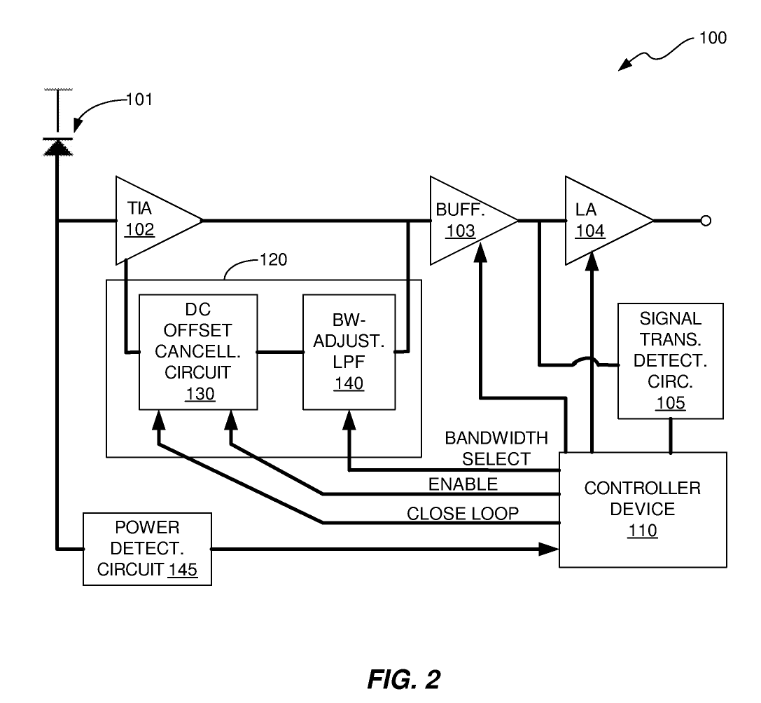

FIG. 2 illustrates a block diagram of an embodiment of an optical RX 100 of an optical receiver or transceiver that incorporates the DC offset cancellation system and method. A photodetector 101 of the RX 100 detects an optical data signal containing bits of data transmitted over an optical waveguide (e.g., an optical fiber, which is not shown) to the RX 100. The receiver or transceiver module that contains the RX 100 typically includes some type of optics system (not shown) that directs the optical data signal output from the end of the optical waveguide onto the photodetector 101. The photodetector 101 may be any type of suitable optical detector, such as, for example, a photodiode. The photodetector 101 generates an electrical current signal in response to the optical data signal received thereby, which is provided to the input of a TIA 102. The TIA 102 converts the electrical current signal into a differential electrical voltage signal, which is then input to a buffer, which operates as a gain stage to increase the amplitude of the voltage signal. The output of the buffer 103 is then provided to the input of a LA 104, which quantizes or limits the differential voltage signal. This limited voltage signal is most often the output of the RX 100, but it may also be processed by one or more other components (not shown) of the RX 100 or transceiver, such as a clock and data recovery (CDR) circuit (not shown), for example.

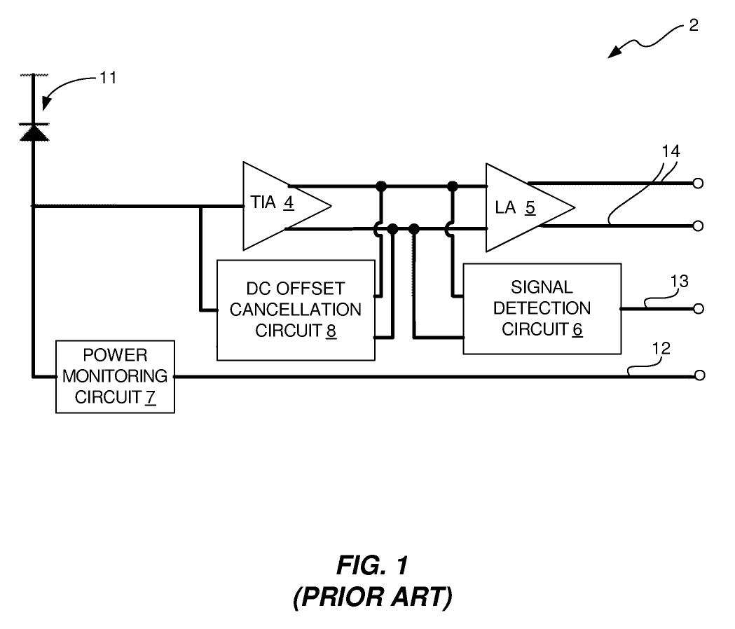

The buffer 103 is not required, but is often included in the RX 100 to provide additional gain or level shifting in front of the LA 104. In the event that the buffer 103 is used, a signal transition detection (XD) circuit 105 receives the voltage signal output from the buffer 103. In the event that the buffer 103 is not used, the signal XD circuit 105 receives the voltage signal that is output from the TIA 102. In either case, the signal XD circuit 105 detects when there is a transition from a logic 0 level to a logic 1 level, and vice versa. The signal transition detection function performed by the signal XD circuit 105 is a different function from that performed by the signal detection circuit 6 shown in FIG. 1. The signal detection circuit 6 shown in FIG. 1 detects the amplitude of the voltage signal output from the TIA 4 shown in FIG. 1 and outputs a voltage signal that is indicative of whether the detected amplitude is higher low than a preselected TH value. The signal detection circuit 6 does not detect transitions from a logic 1 level to a logic 0 level, and vice versa. In contrast, the signal transition detection (XD) circuit 105 detects such transitions and outputs a voltage signal that indicates when a transition in the data signal has occurred.

A controller device 110 of the RX 100 comprises control circuitry configured to perform the aforementioned feedback loop control algorithm that causes the RX 100 to perform the method of the invention, as will be described below in detail. The RX 100 includes a DC offset cancellation (OC) system 120 that is controlled by the controller device 110. The DC OC system 120 comprises a DC OC circuit 130 and a bandwidth-selectable LPF 140. The manner in which the DC OC circuit 130 and the bandwidth-selectable LPF 140 are controlled by the controller device 110 is described below in detail. The RX 100 typically also includes an optical power (usually average power) detection (PD) circuit 145, which receives the electrical current signal produced by the photodetector 101 and detects when the electrical current signal indicates that any usable amount (i.e., sufficiently above the noise floor) of optical power is being received by the photodetector 101.

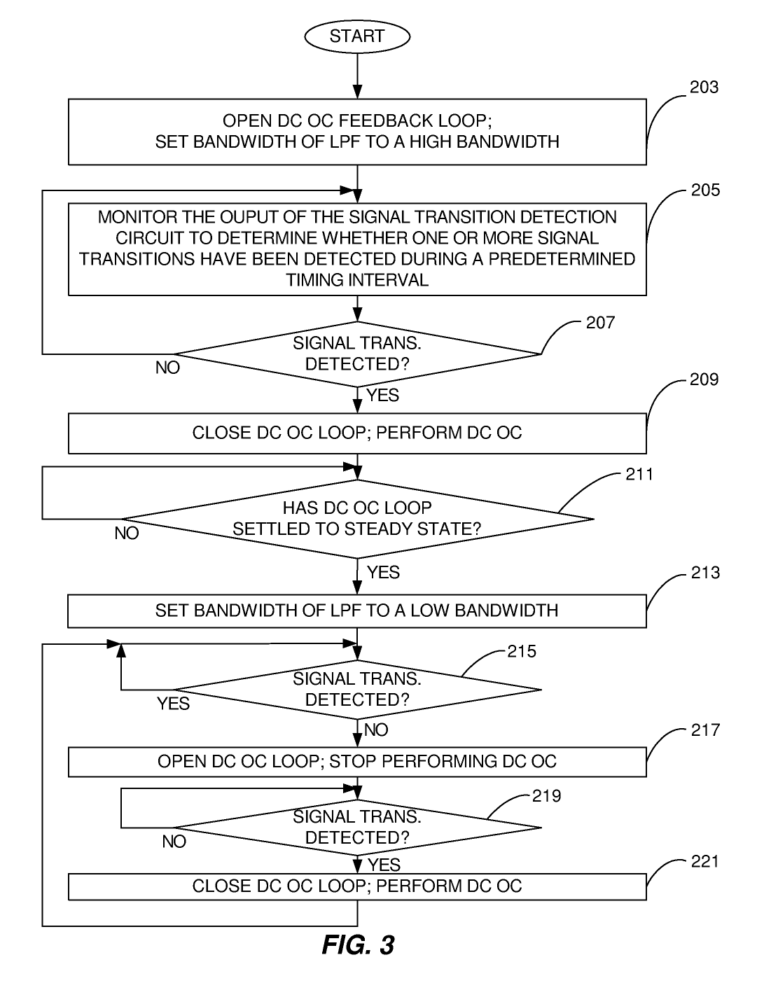

FIG. 3 illustrates a flowchart that represents the method performed by an RX in accordance with one illustrative embodiment. For illustrative purposes, the flowchart of FIG. 3 will be described with reference to the RX 100 shown in FIG. 2. At startup, the DC OC feedback loop is opened and the bandwidth of the LPF 140 is set to a high bandwidth, as indicated by block 203. Opening the DC OC feedback loop means that the data signal is allowed to flow through to the output, but DC offset cancellation is not performed. Thus, opening the DC OC feedback loop can be thought of as disabling the DC OC system 120 to freeze the state of the DC OC system 120 while still allowing data to pass through to the output. The controller device 110 monitors the output of the signal XD circuit 105 to determine whether one or more transitions in the input data signal have been detected during a predetermined timing interval, as indicated by block 205. If it is determined by the controller device 110 at block 207 that one or more signal transitions have been detected during the predetermined timing interval, then the process proceeds to block 209 at which the DC OC feedback loop is closed, thereby allowing the state of the loop to correct for any DC offsets (optimizing the slicing threshold).

While DC offset cancellation is being performed, a period of time passes before the DC OC feedback loop has settled to its steady state condition. Block 211 represents the controller device 110 waiting for the DC OC feedback loop to settle to its steady state condition in which the DC OC system 120 has removed the DC offset. After the DC OC feedback loop has settled to its steady state condition, the controller device 110 sets the bandwidth of the LPF 140 to a low bandwidth, as indicated by block 213. After the bandwidth of the LPF 140 has been set to the low bandwidth, a determination is made by the controller device 110 at block 215 as to whether or not the signal output from the signal XD circuit 105 indicates that one or more signal transitions have been detected within the predetermined timing interval. If so, the process remains at block 215 and DC offset cancellation continues to be performed.

If it is determined at block 215 that one or more signal transitions have not been detected during the predetermined timing interval, then the DC OC feedback loop is opened and the DC OC system 120 stops performing DC offset cancellation, as indicated by block 217. After the DC OC feedback loop has been opened and the DC OC system 120 stops performing DC offset cancellation, the process proceeds to block 219 where the controller device 110 once again determines whether one or more transitions in the input data signal have been detected during the predetermined timing interval. If not, the process remains at block 219 and the controller device 110 continues to monitor the output of the signal XD circuit 105 to determine whether one or more signal transitions have been detected during the predetermined timing interval. If at block 219 it is determined that one or more signal transitions have been detected during the predetermined timing interval not, then the process proceeds to block 221. At block 221, the controller device 110 closes the DC OC feedback loop and again performs DC offset cancellation. While performing DC offset cancellation, the process returns to block 215 where the controller device 110 continues to check to determine whether or not one or more signal transitions are still being detected within the predetermined timing interval. If so, the process remains at block 215. If not, the process proceeds again to block 217, at which the controller device 110 opens the DC OC feedback loop, causing the DC OC system 120 to stop performing DC offset cancellation. From block 217, the process again proceeds to block 219.

It can be seen from the above description of FIG. 3 that after the bandwidth of the LPF has been set to the low bandwidth at block 213, the process immediately checks to determine whether or not one or more transitions in the input data signal are still being detected by the signal XD circuit 105. If one or more signal transitions are not still being detected, then the process immediately proceeds to block 217, at which the DC OC feedback loop is immediately opened to prevent DC offset cancellation from continuing to be performed. If one or more signal transitions are subsequently detected at block 219, the process proceeds again to block 221 where the DC OC feedback loop is closed such that the DC OC system recommences performing DC offset correction. As soon as the controller device 110 determines that the signal XD circuit 105 is no longer detecting transitions in the input data signal (block 215), the DC OC feedback loop is opened to prevent DC offset cancellation from being performed (block 217). These features prevent the system from drifting in the absence of transitions in the input data signal.

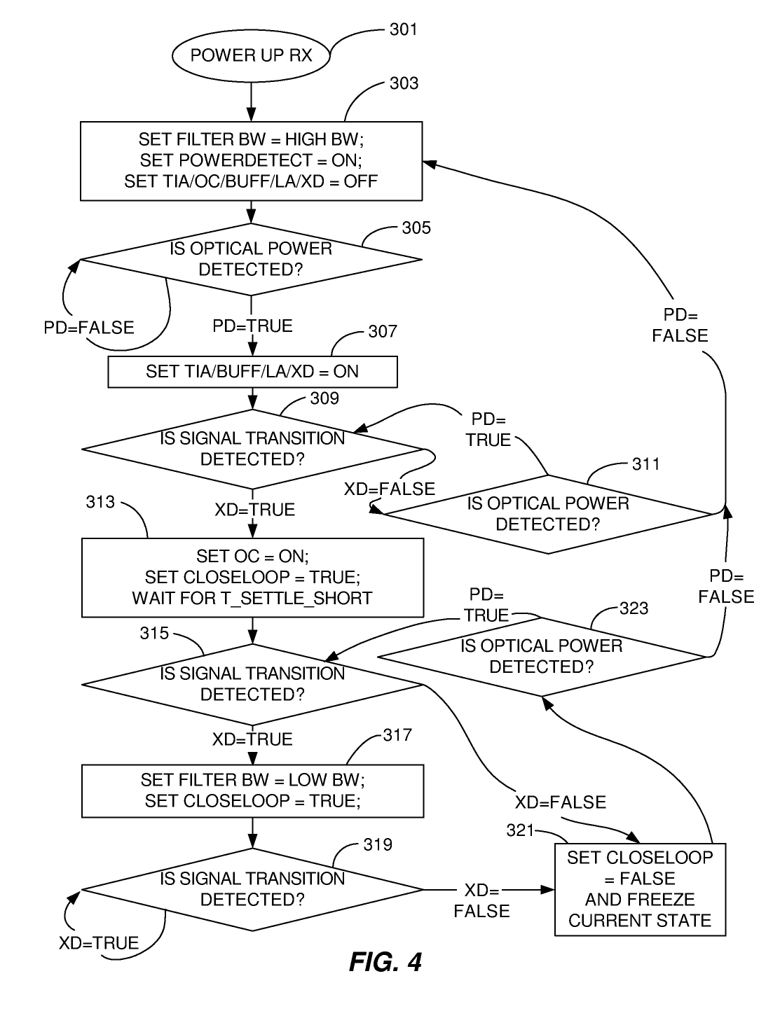

Setting the LPF 140 to the high BW at startup allows the DC OC feedback loop to converge to its steady state more rapidly than if the LPF 140 is set to its normal low BW at startup. This rapid convergence of the feedback loop to steady state provides a reduced settling time period for the RX 100 compared to that of the known RX 2 shown in FIG. 1. This reduced settling time period helps ensure that the RX 100 will meet link startup settling time limits while, at the same time, having the steady state behavior/performance that is achieved when the LPF 140 is at the lower BW. In addition, this feature is especially advantageous in situations where the RX 100 is used for burst data mode operations in which the RX 100 may be powered down when data is not being received to conserve power, as will be described below with reference to FIG. 4. Once the LPF 140 has settled to its steady state, DC offset cancellation is performed by the DC OC system 120.

The method described above with reference to FIG. 3 may be modified in a number of ways. For example, power savings steps can be added to the method to cause electrical power to one or more of the circuit components of the RX 100 to be turned off when optical power is not being detected by the optical PD circuit 145 and/or when transitions are not being detected by the signal XD circuit 105.

FIG. 4 illustrates a state diagram that demonstrates the method performed by the RX 100 shown in FIG. 2 in accordance with another illustrative embodiment in which certain power saving steps and performance enhancing steps are included in the feedback control algorithm. As described above with reference to FIG. 3, the DC OC system 120 is enabled and disabled based on the status of the input signal to the TIA 102, i.e., based on whether the input signal is a modulated signal that is transitioning from a logic 1 level to a logic 0 level, or vice versa. The signal XD circuit 105 detects the presence or absence of these signal transitions, and the feedback control algorithm performed by the controller device 110 controls the DC OC system 120 based on whether or not signal transitions are being detected. The disabling and enabling of the DC OC system 120 will be referred to hereinafter as opening and closing, respectively, the feedback loop of the RX 100. As indicated above, enabling the DC OC system 120 means that the DC OC system 120 is placed in a state in which it performs DC offset cancellation (OC), whereas disabling the DC OC system 120 means that the DC OC system 120 is placed in another state in which it does not perform DC OC. However, in both of these states, the data signal is allowed to pass through the system.

The state diagram demonstrates one possible implementation of a semi-open loop RX 100 in accordance with one illustrative embodiment. The term “POWERDETECT” is used in the state diagram as a variable having a state that indicates whether or not the optical PD circuit 145 is turned on or off. The term “PD” is used in the state diagram as a variable that represents the state of the output of the optical PD circuit 145, i.e., whether or not optical power is currently being detected by the photodetector 101. The term “OC” is used in the state diagram to represent the DC OC circuit 130. The term “XD” is used as a variable in the state diagram to represent the state of the output of the signal XD circuit 105, i.e., whether or not one or more transitions in the input signal to the RX 100 are currently being detected. The term “BW” is used in the state diagram to represent the bandwidth of the bandwidth-adjustable LPF 140. The term “CLOSELOOP” is used as a variable in the state diagram to represent whether the RX feedback loop is in the opened or closed state, i.e., whether or not the DC OC circuit 130 is disabled or enabled, respectively.

Starting at power up of the RX 100, which is represented by block 301, the feedback loop control algorithm RX 100 enters the state represented by block 303 in which most of the circuitry of the RX 100 is inactive. In this state, electrical power to the TIA 102, the DC OC circuit 130, the buffer 103, the LA 104, and the signal XD circuit 105 is turned off, while electrical power to the optical PD circuit 145 is turned on. Thus, the TIA 102, the DC OC circuit 130, the buffer 103, the LA 104, and the signal XD circuit 105 are set to OFF and the optical PD circuit 145 is set to ON. In this state, feedback loop control algorithm sets the BW of the LPF 140 to a High BW. Setting the BW of the LPF 140 to the High BW enables the LPF 140 to settle more rapidly when the RX 100 is powered on than would otherwise be the case if the LPF 140 were set to a lower BW typically used to perform DC offset cancellation.

The feedback loop control algorithm then enters the state represented by block 305, during which it waits for the controller device 110 to receive an indication from the optical PD circuit 145 that some level of input optical power is detected. If optical power is not detected, PD is set to False. The algorithm remains in this state until the output of the optical PD circuit 145 indicates that optical power is detected, in which case it sets PD equal to True. Once optical power is detected and PD has been set to True, the control algorithm enters the state represented by block 307. In this state, the TIA 102, the buffer 103, the LA 104, and the signal XD circuit 105 are set to ON, meaning that electrical power is being provided to these circuits. The RX 100 then enters the state represented by block 309. In this state, the controller device 110 monitors the output of the signal XD circuit 105 and determines whether one or more signal transitions are being detected, i.e., whether the input signal contains data as indicated by transitions from a logic 1 level to a logic 0 level, or vice versa, within a predetermined timing interval. If transitions are not detected in this state, XD is set to False and the RX 100 enters the state represented by block 311. In this state, the controller device 110 continues to monitor the output of the optical PD circuit 145 to determine whether or not any optical power is still being detected. This allows the RX 100 to return to its lowest power state in the event that there was a spurious application of DC light that never transitioned to modulated data. The RX 100 remains in one of the states represented by blocks 309 and 311 until XD becomes True, i.e., until the controller device 110 determines that the input signal to the RX 100 contains data.

If the controller device 110 determines that the input signal to the RX 100 contains data, as indicated by the output of the signal XD circuit 105, then the feedback loop control algorithm enters the state represented by block 313. In this state, OC is set to ON, CLOSELOOP is set to True, and the controller device 110 sets a counter (not shown) to a count value corresponding to a short settling time period, T_Settle_Short. Setting CLOSELOOP to True enables the DC OC circuit 130. The controller device 110 then waits for the short settling time period to pass while the DC OC feedback loop is converging to its initial steady state solution. Because the BW of the LPF 140 was previously set to the High BW when the RX 100 entered the state represented by block 303, only a short settling time period is required for the LPF 140 to settle to its steady state value once the RX 100 has entered the state represented by block 313.

At the end of the short settling time period, the feedback loop control algorithm enters the state represented by block 315. In the state represented by block 315, the controller device 110 monitors the output of the signal XD circuit 105 and determines whether one or more signal transitions are still being detected within the predetermined timing interval, i.e., whether the input signal still contains data. If signal transitions are no longer being detected in this state, the control algorithm sets XD equal to False and then enters the state represented by block 321. In this state, the controller device 110 sets CLOSELOOP to False and freezes, or saves, the current state. Setting CLOSELOOP to false disables the DC OC circuit 130 to prevent DC OC from being performed. The control algorithm then enters the state represented by block 323. In the state represented by block 323, the controller device 110 continues to monitor the output of the optical PD circuit 145 and determine whether or not any optical power has been detected. The purpose of entering this state is to enable the controller device 110 to distinguish between a long string of consecutive 1 or 0 data bits and a complete loss of input data. If a long bit run length is being detected, the controller device 110 will continue to look for data transitions to determine when it should return to closed loop operation. However, if input data is turned off completely and optical power is no longer being detected, the control algorithm re-enters the state represented by block 303, in which the RX 100 powers down the TIA 102, the buffer 103, the LA 104, the signal XD circuit 105, and the DC OC circuit 130. Powering down these components allows the RX 100 to conserve electrical power when no optical power is being detected by the optical PD circuit 145.

When the loop control algorithm is in the state represented by block 315 and the controller device 110 determines that XD is still true (i.e., that one or more signal transitions are still being detected by the signal transition detection circuit 105), it then enters the state represented by block 317. In this state, the controller device 110 causes the BW of the LPF 140 to switch from the High BW set in the state represented by block 303 to a Low BW. The RX 100 has more pattern sensitivity in the High BW mode than in the Low BW mode, which results in there being some residual DC offset in the High BW mode that will still need to be cancelled out by the DC OC system 120. The reduced pattern sensitivity in the Low BW mode allows the DC OC loop to settle to a minimum offset condition that provides the best BER performance.

After the LPF 140 has been set to the Low BW and CLOSELOOP has been set to True, the RX 100 enters the state represented by block 319. In this state, the DC OC system 120 continues to perform DC offset cancellation while the controller device 110 continues to monitor the output of the signal XD circuit 105. As long as signal transitions continue to be detected, XD will remain True and DC OC will continue to be performed. If a determination is made in this state that signal transitions are no longer being detected (as indicated by XD changing from True to False), the loop control algorithm will then enter the state represented by block 321. As described above, in this state, the controller device 110 sets CLOSELOOP to False and saves and freezes the current state. The loop control algorithm then enters the state represented by block 323. As described above, in the state represented by block 323, the controller device 110 continues to monitor the output of the optical PD circuit 145 and determine whether or not any optical power is still being detected. If optical power is no longer detected, the loop control algorithm re-enters the state represented by block 303, in which the RX 100 powers down the TIA 102, the buffer 103, the LA 104, the signal XD circuit 105, and the DC OC circuit 130. If optical power continues to be detected while the RX 100 is in the state represented by block 323, the loop control algorithm will re-enter the state represented by block 315 to look for the return of data transitions.

One of the advantages of the method represented by the state diagram shown in FIG. 4 is that the feedback loop settles more rapidly at power up due to the LPF 140 being set to the High BW than in known optical RXs of the type described above with reference to FIG. 1. Another advantage of the method demonstrated by the state diagram shown in FIG. 4 is that the feedback loop is only closed after signal transitions have been detected, which prevents data transmitted with low frequency content and long patterns of consecutive logic 1s and logic 0s without reducing the cutoff frequency as low as would be needed with the typical closed loop DC cancellation. Another advantage of the method represented by the state diagram shown in FIG. 4 is that electrical power is saved by the powering down of the TIA 102, the buffer 103, the LA 104, and the signal XD circuit 105 when a determination is made that optical power is not being received by the RX 100. Yet another advantage of the method represented by the state diagram shown in FIG. 4 is that when the feedback loop is opened (i.e., CLOSELOOP set to False) in the state represented by block 321, the current state of the LPF 140 is frozen, or saved. Saving the current state of the LPF 140 in this manner is optional, but preferred, because it allows the feedback loop to converge to its steady state more rapidly when the feedback loop closed again at a later time. In other words, saving the current state allows the most recent loop steady state solution to be used as the initial condition the next time the process enters the state represented by block 317 (closed loop) so that the amount of time that it takes for the loop to settle to its new steady state condition is shorter than the amount of time previously required.

It should be noted that in between the instant in time when the signal XD circuit 104 detects no signal transition and the instant in time that the DC OC feedback loop is opened, there may be a certain amount of drift in the DC OC circuit 130 that is associated with the BW of the LPF 140. In a typical DC OC circuit, such as the DC OC circuit 8 described above with reference to FIG. 1, this drift sets the maximum signal run length (i.e., the number of consecutive logic 1s or consecutive logic 0s) that can be tolerated. In contrast, opening the feedback loop of the RX 100 shown in FIG. 3 enables the maximum run length of data that can be tolerated by the RX 100 to be extended almost indefinitely without excessive drift of the slicing threshold due to the DC OC system 120. Drifts due to temperature changes, optical input power changes, device leakage and other factors will limit how long a run length you can ultimately handle.

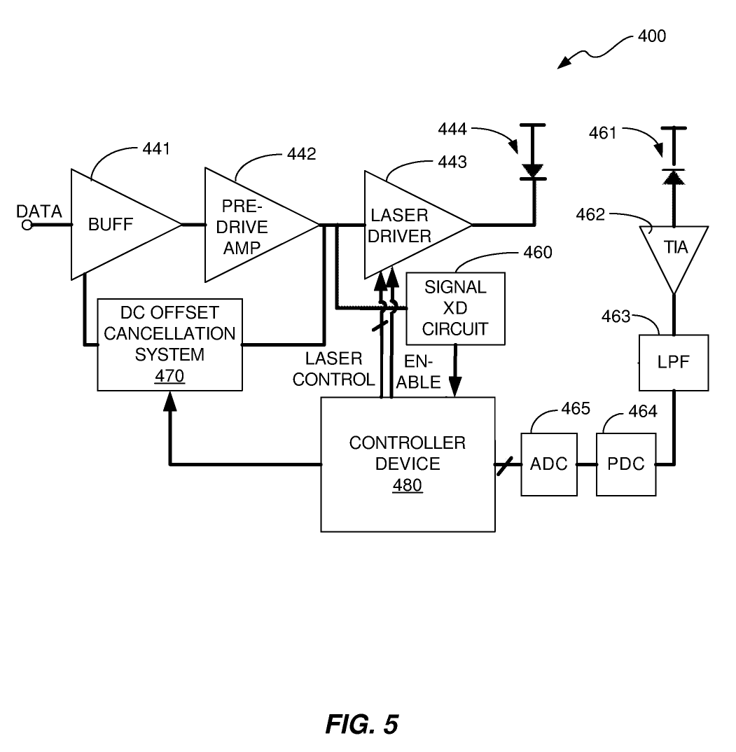

FIG. 5 illustrates a block diagram of an optical TX 400 that incorporates a DC OC system 470 that may be identical to the DC OC system 120 described above with reference to FIG. 2. The optical TX 400 may be part of a stand-alone optical TX or part of an optical transceiver module that includes both a TX and an RX. A DC OC system is not always needed in a TX, but in cases in which a DC OC system is needed or desired, the TX 400 includes the DC OC system 470. In addition, the TX includes a buffer 441, a pre-drive amplifier 442, a laser driver circuit 443, a laser diode 444, a signal XD circuit 460, and a controller device 480.

The input data signal, which is labeled “DATA”, is received by the buffer 441, which provides the input data signal with some gain. The output of the buffer 441 is received by the pre-drive amplifier 442, which amplifies the signal to provide it with some additional gain. Thus, the combination of the buffer 441 and the pre-drive amplifier 442 is essentially an input gain stage, which may be configured in a variety of ways. The output of the pre-drive amplifier 442 is received by the laser driver circuit 443 and by the signal XD circuit 460. The signal XD circuit 460 performs the same functions as those performed by the signal XD circuit 105 described above with reference to FIG. 2. The output of the signal XD circuit 460 is input to the controller device 480. The controller device 480 controls the operations of the DC OC system 470 and of the laser driver circuit 443. The output of the laser driver circuit 443 is received by the laser diode 444, which generates optical data signals in accordance with the output of the laser driver circuit 443.

The signal XD circuit 460 detects when one or more transitions are occurring in the input data signal and produces a corresponding output signal, XD. The controller device 480 is configured to perform a feedback loop control algorithm that is identical or similar to the feedback loop control algorithm described above with reference to FIGS. 3 and 4 to adjust the BW of the LPF of the DC OC system 470 and to enable/disable the DC OC system 470 based on whether or not the input signal to the TX 400 contains data. Therefore, a detailed description of the DC OC system 470 will not be provided herein in the interest of brevity.

The controller devices 110 shown in FIG. 2 and 480 shown in FIG. 5 may be virtually any type of suitable computational device such as, for example, a microprocessor, a microcontroller, an application specific integrated circuit (ASIC), a programmable gate array (PGA), a programmable logic array (PLA), an integrated digital state machine, etc. The controller devices 110 and 480 are typically state machines comprising combinational logic configured to perform the functionality described above with reference to FIGS. 2-5. The controller devices 110 and 480 are typically integrated into the RX and TX integrated circuits (ICs), respectively.

It should be noted that the invention has been described with respect to illustrative embodiments for the purpose of describing the principles and concepts of the invention. The invention is not limited to these embodiments. For example, while the invention has been described with reference to using a particular RX or TX configuration, the invention is not limited to these particular configurations. Also, the state diagram shown in FIG. 4 demonstrates one example of the manner in which the RX portion may operate to perform the method. Variations can be made to the state diagram shown in FIG. 4 while still achieving the goals of the invention. Thus, the invention is not limited to the particular embodiments represented by the state diagram. As will be understood by those skilled in the art in view of the description being provided herein, many modifications may be made to the embodiments described herein without deviating from the goals of the invention, and all such modifications are within the scope of the invention.

What is claimed is:

1. An apparatus for use in an optical communications device for performing direct current (DC) offset cancellation (OC), the apparatus comprising:
a feedback loop having a first node that is electrically coupled to an input of the communications device and having a second node that is electrically coupled to an output of a gain stage of the communications device, the feedback loop including a DC OC circuit and a low pass filter (LPF) circuit, the LPF having a bandwidth (BW) that is adjustable, the LPF circuit having an input that is electrically coupled to the second node of the feedback loop and having an output that is electrically coupled to an input of the DC OC circuit, the DC OC circuit having an output that is electrically coupled to the first node of the feedback loop;
a signal transition detection (XD) circuit electrically coupled to the output of the gain stage, the signal XD circuit being configured to detect signal transitions in an input signal to the communications device between a logic 0 level and a logic 1 level and to output an indication of whether or not at least one signal transition has been detected; and
a controller device electrically coupled to the DC OC circuit, the LPF and the signal XD circuit, the controller device being configured to perform a feedback loop control (FLC) algorithm, the controller device receiving the indication output from the signal XD circuit, wherein the FLC algorithm enables the DC OC circuit to perform DC OC based at least in part on the indication received by the controller device from the signal XD circuit, and wherein the FLC algorithm disables the DC OC circuit from performing DC OC based at least in part on the indication received by the controller device from the signal XD circuit.

2. The apparatus of claim 1, wherein the FLC algorithm disables the DC OC circuit from performing DC OC if the indication received in the controller device from the signal XD circuit indicates that at least one signal transition has not been detected during the particular timing interval.

3. The apparatus of claim 2, wherein the FLC algorithm enables the DC OC circuit to perform DC OC if the indication received in the controller device from the signal XD circuit indicates that at least one signal transition been detected during the particular timing interval.

4. The apparatus of claim 3, wherein the optical communications device includes an optical power detection (PD) circuit configured to receive an electrical output signal produced by an optical detector of the communications device and to produce an output signal indicative of whether or not optical power is being detected by the optical detector, wherein the output signal produced by the optical PD circuit is received by the controller device, and wherein the FLC algorithm causes electrical power to the DC OC circuit and one or more other circuits of the communications device to be turned off if the output signal produced by the optical PD circuit indicates that no optical power is being detected by the optical detector, and wherein the FLC algorithm causes electrical power to be provided to the DC OC circuit if the output signal received in the controller device from the optical PD circuit indicates that optical power is being detected by the optical detector, and wherein the FLC algorithm only enables the DC OC circuit to perform DC OC if the output signal received in the controller device from the optical PD circuit indicates that optical power is being detected by the optical detector and the indication received in the controller device from the signal XD circuit indicates that at least one signal transition been detected during the particular timing interval.

5. The apparatus of claim 3, wherein when the optical communications device is initially powered on, the FLC algorithm causes the BW of the LPF to be set to a High BW, and wherein if the FLC algorithm determines after a period of time that at least one signal transition has been detected during the particular timing interval, the FLC algorithm causes the DC OC circuit to be enabled and causes the BW of the LPF to be set to a Low BW, wherein the Low BW is lower than the High BW.

6. The apparatus of claim 1, wherein the optical communications device is a stand-alone optical receiver.

7. The apparatus of claim 6, wherein the stand-along optical receiver has multiple receive channels for receiving multiple respective optical data signals, and wherein each receive channel includes an instance of the apparatus.

8. The apparatus of claim 1, wherein the optical communications device is a stand-alone optical transmitter.

9. The apparatus of claim 8, wherein the stand-along optical transmitter has multiple transmit channels for transmitting multiple respective optical data signals, and wherein each channel includes an instance of the apparatus.

10. The apparatus of claim 1, wherein the optical communications device is an optical transceiver comprising a receiver portion and a transmitter portion, and wherein the apparatus is incorporated only into the receiver portion.

11. The apparatus of claim 1, wherein the optical communications device is an optical transceiver comprising a transmitter portion and a receiver portion, the transmitter portion having at least one transmit channel and the receiver portion having at least one receive channel, and wherein at least one of the transmitter portion and the receiver portion includes the apparatus.

12. The apparatus of claim 11, wherein the optical transceiver is a parallel optical transceiver, and wherein the transmitter portion has multiple transmit channels and multiple receive channels, and wherein each channel includes an instance of the apparatus.

13. The apparatus of claim 1, wherein the optical communications device is an optical transceiver comprising a receiver portion and a transmitter portion, and wherein the apparatus is incorporated only into the transmitter portion.

14. The apparatus of claim 1, wherein the optical communications device is an optical transceiver comprising a receiver portion and a transmitter portion, and wherein a first instance of the apparatus is incorporated into the receiver portion and wherein a second instance of the apparatus is incorporated into the transmitter portion.

15. The apparatus of claim 1, wherein the optical communications device includes an optical power detection (PD) circuit and an optical detector, and wherein the optical PD circuit is configured to receive an electrical output signal produced by the optical detector of the communications device and to produce an output signal indicative of whether or not optical power is being detected by the optical detector, wherein the output signal produced by the optical PD circuit is received by the controller device, and wherein the FLC algorithm causes electrical power to the DC OC circuit and one or more other circuits of the communications device to be turned off if the output signal produced by the optical PD circuit indicates that no optical power is being detected by the optical detector of the communications device, and wherein the FLC algorithm causes electrical power to the DC OC circuit to be turned on if the output signal produced by the optical PD circuit indicates that optical power is being detected by the optical detector.

16. The apparatus of claim 15, wherein the FLC algorithm only enables the DC OC circuit to perform DC OC if the output signal received in the controller device from the optical PD circuit indicates that optical power is being detected by the optical detector and the indication received in the controller device from the signal XD circuit indicates that at least one signal transition has been detected during the particular timing interval.

17. A method for performing direct current (DC) offset cancellation (OC) in an optical communications device, the method comprising:
providing a DC OC feedback loop in the optical communications device having a DC OC circuit and a low pass filter (LPF), the feedback loop having a first node electrically coupled to an input of the communications device and having a second node electrically coupled to an output of a gain stage of the communications device, the LPF having a bandwidth (BW) that is adjustable, the LPF circuit having an input that is electrically coupled to the second node of the feedback loop and having an output that is electrically coupled to an input of the DC OC circuit, the DC OC circuit having an output that is electrically coupled to the first node of the feedback loop;
providing a signal transition detection (XD) circuit in the communications device, the XD circuit being electrically coupled to the output of the gain stage, the signal XD circuit being configured to detect signal transitions in an input signal to the communications device between a logic 0 level and a logic 1 level and to output an indication of whether or not at least one signal transition has been detected; and
providing a controller device in the communications device, the controller device being configured to perform a feedback loop control (FLC) algorithm, the controller device receiving the indication output from the signal XD circuit;
with the controller device, the FLC algorithm causing the DC OC circuit to be enabled to perform DC OC and to be disabled from performing DC OC based at least in part on the indication received by the controller device from the signal XD circuit.

18. The method of claim 17, wherein the FLC algorithm disables the DC OC circuit if the indication received in the controller device from the signal XD circuit indicates that at least one signal transition has not been detected during the particular timing interval.

19. The method of claim 17, wherein the FLC algorithm enables the DC OC circuit if the indication received in the controller device from the signal XD circuit indicates that at least one signal transition been detected during the particular timing interval.

20. The method of claim 19, wherein the communications device includes an optical power detection (PD) circuit and an optical detector, the optical PD circuit being configured to receive an electrical output signal produced by the optical detector of the communications device and to produce an output signal indicative of whether or not optical power is being detected by the optical detector, wherein the output signal produced by the optical PD circuit is received by the controller device, the method further comprising:
by the controller device executing the FLC algorithm, causing electrical power to the DC OC circuit and one or more other circuits of the communications device to be turned off if the output signal produced by the optical PD circuit indicates that no optical power is being detected by the optical detector of the communications device, and wherein when the controller device executes the FLC algorithm, the controller device enables the DC OC circuit only if the output signal received in the controller device from the optical PD circuit indicates that optical power is being detected by the optical detector and the indication received in the controller device from the signal XD circuit indicates that at least one signal transition been detected during the particular timing interval.

21. The method of claim 20, wherein the communications device is a stand-alone optical receiver.

22. The method of claim 20, wherein the communications device is a stand-alone optical transmitter.

23. The method of claim 20, wherein the communications device is an optical transceiver comprising a receiver portion and a transmitter portion, and wherein the method is performed only in the receiver portion.

24. The method of claim 20, wherein the communications device is an optical transceiver comprising a receiver portion and a transmitter portion, and wherein the method is performed only in the transmitter portion.

25. The method of claim 20, wherein the communications device is an optical transceiver comprising a receiver portion and a transmitter portion, and wherein the method is performed in the receiver portion and in the transmitter portion.

26. The method of claim 18, further comprising:
when the communications device is initially powered on, the FLC algorithm causes the BW of the LPF to be set to a High BW, and wherein if the FLC algorithm determines after a period of time that at least one signal transition has been detected during the particular timing interval, the FLC algorithm causes the DC OC circuit to be enabled to perform DC OC and causes the BW of the LPF to be set to a Low BW, wherein the Low BW is lower than the High BW.

27. The method claim 26, wherein the communications device includes an optical power detection (PD) circuit configured to receive an electrical output signal produced by an optical detector of the communications device and to produce an output signal indicative of whether or not optical power is being detected by the optical detector, wherein the output signal produced by the optical PD circuit is received by the controller device, the method further comprising:
in the controller device, through execution of the FLC algorithm, causing electrical power to the DC OC circuit and one or more other circuits of the communications device to be turned off if the output signal produced by the optical PD circuit indicates that no optical power is being detected by the optical detector of the communications device, and wherein the FLC algorithm only enables the DC OC circuit if the output signal received in the controller device from the optical PD circuit indicates that optical power is being detected by the optical detector and if the indication received in the controller device from the signal XD circuit indicates that at least one signal transition been detected during the particular timing interval.
